(19) United States
(12) Patent Application Publication
(10) Pub. No.: US 2014/0040447 A1
(43) Pub. Date: Feb. 6, 2014

(54) MANAGEMENT SYSTEM AND PROGRAM PRODUCT

(71) Applicant: Kentaro Watanabe, Yokohama (JP)

(72) Inventor: Kentaro Watanabe, Yokohama (JP)

(73) Assignee: Hitachi, Ltd.

(21) Appl. No.: 13/817,379

(22) PCT Filed: Jul. 31, 2012
(86) PCT No.: PCT/JP2012/069434

§ 371 Date: Feb. 15, 2013

(51) Int. Cl. H04L 12/24

(52) U.S. Cl. CPC H04L 41/50
USPC 709/223

(57) ABSTRACT

A management system for managing one or more information processing apparatuses through a network includes a storage part that stores various tables and a controller that controls execution of a predetermined operation according to an execution request of the operation. The storage part stores the predetermined operation and one or more realization means of the operation in association with each other. The controller receives the execution request of the operation, specifies one or more realization means of the operation corresponding to the operation, and selects realization means of the operation that can be executed from the specified one or more realization means on the basis of management information including configuration information and operation information of the information processing apparatuses.

### FIELD OF THE INVENTION

The present invention relates to a management system and a program product and is suitable to be applied to a management system and a program product which select an operation task scenario and perform an operation task.

### BACKGROUND OF THE INVENTION

Generally, a data center in a company is operated according to an operation procedure manual (operation scenario) (generally also referred to as RunBook) in which operation procedures are described step by step.

In recent years, a usage model called cloud computing has emerged as business needs have changed and load has increased. The cloud computing means a usage model where IT infrastructure resources are dynamically enhanced, a usage model where IT infrastructure resources located in each section are integrated into a data center and IT resources in the data center are rented by the hour to each section, and the like.

In the cloud computing environment (hereinafter may be referred to as “cloud environment”), operations performed in each section are changed to a centralized operation in the data center and operations such as borrowing and returning virtual resources are frequently performed. Therefore, automation of operations in accordance with an operation procedure manual (RunBook Automation (RBA)) attracts attention in order to reduce operation load and improve operation quality in a data center operation in the cloud environment.

For example, Japanese Unexamined Patent Application Publication No. 2005-092542 and Japanese Unexamined Patent Application Publication No. 2007-310876 disclose techniques that support automatic execution of operations.

### SUMMARY OF THE INVENTION

However, in Japanese Unexamined Patent Application Publication No. 2005-092542 and Japanese Unexamined Patent Application Publication No. 2007-310876 mentioned above, the operation scenario is described in an operation by a specific realization means, so that there is a problem that an operation can be executed only by a predetermined specific realization means even though a plurality of realization means can be executed in practice and thus it is not possible to execute an appropriate operation according to various situations considering an infrastructure environment and a system environment. For example, when a failure occurs in an infrastructure environment, even if there is a realization means other than the predetermined specific realization means, this substitute means cannot be executed.

The present invention is made in view of the above problem and provides a management system and a program which can execute an appropriate operation according to various situations.

To solve the above problem, the present invention provides a management system for managing one or more information processing apparatuses through a network. The management system includes a storage part that stores various tables and a controller that controls execution of a predetermined operation according to an execution request of the operation. The storage part stores the predetermined operation and one or more realization means of the operation in association with each other. The controller receives the execution request of the operation, specifies one or more realization means of the operation corresponding to the operation, and selects realization means of the operation that can be executed from the specified one or more realization means on the basis of management information including configuration information and operation information of the information processing apparatuses.

According to the above configuration, a predetermined operation and one or more realization means of the operation are stored in the storage part in association with each other and the controller receives an execution request of an operation and specifies one or more realization means of the operation corresponding to the operation. The controller selects executable realization means of the operation on the basis of the management information such as the configuration information and the operation information of the information processing apparatuses connected through a network. Thereby, it is possible to specify one or more realization means of the operation corresponding to the execution request of the operation, select realization means of the operation from the specified realization means of the operation on the basis of the configuration information, the operation information, and the like of the information processing apparatuses to be managed, and execute an appropriate operation according to various situations.

According to the present invention, an appropriate operation can be executed according to various situations.

### BRIEF DESCRIPTION OF THE DRAWINGS

FIG. 1 is a block diagram showing a configuration of an information processing system according to an embodiment of the present invention;

FIG. 2 is a conceptual diagram of an operation scenario according to the embodiment;

FIG. 3 is a diagram showing an example of a scenario template table according to the embodiment;

FIG. 4 is a diagram showing an example of an operation realization means table according to the embodiment;

FIG. 5 is a diagram showing an example of a scenario plan table according to the embodiment;

FIG. 6 is a diagram showing an example of a configuration information table according to the embodiment;

FIG. 7 is a diagram showing an example of an operation information table according to the embodiment;

FIG. 8 is a diagram showing an example of an event table according to the embodiment;

FIG. 9 is a diagram showing an example of an incident table according to the embodiment;

FIG. 10 is a diagram showing an example of a request table according to the embodiment;

FIG. 11 is a flowchart showing an execution process of the operation scenario according to the embodiment;

FIG. 12 is a flowchart showing a scenario plan generation process according to the embodiment;

FIG. 13 is a conceptual diagram showing an example of a management screen according to the embodiment; and

FIG. 14 is a conceptual diagram showing an example of a management screen according to the embodiment.

### DETAILED DESCRIPTION OF THE PREFERRED EMBODIMENTS

Hereinafter, an embodiment of the present invention will be described in detail with reference to the drawings.

In the description below, information in the present invention will be represented as “aaa table”, “aaa list”, “aaa DB”, “aaa queue”, and so on. However, these information items may be represented in a data structure other than table, list, DB, queue, and so on. Therefore, “aaa table”, “aaa list”, “aaa DB”, “aaa queue”, and so on may be referred to as “aaa information” in order to indicate that the information does not depend on a data structure. Further, when content of each information item is described, representations such as “identification information”, “identifier”, “name”, “symbolic name”, and “ID” are used, and these representations can be replaceable with each other.

In the description below, “program” may be used as the subject. However, when the program is executed by a processor, a predetermined process is performed using a memory and a communication port (communication control device), so that the processor may be used as the subject. A process disclosed by using the program as the subject may be a process executed by a computer or an information processing apparatus such as a management server. A part or entire of the program may be realized by dedicated hardware.

Various programs may be installed in each computer by a program distribution server or a computer-readable storage medium.

### (1) Configuration of Information Processing System

### (1-1) Hardware Configuration and Software Configuration of Information Processing System

First, an information processing system 1 according to the embodiment will be described. In the embodiment, a management server 100 described below includes a plurality of scenario execution means to automatically execute an operation and selects an optimal scenario execution means from the plurality of scenario execution means according to states of an infrastructure environment and a system environment to execute the scenario execution means.

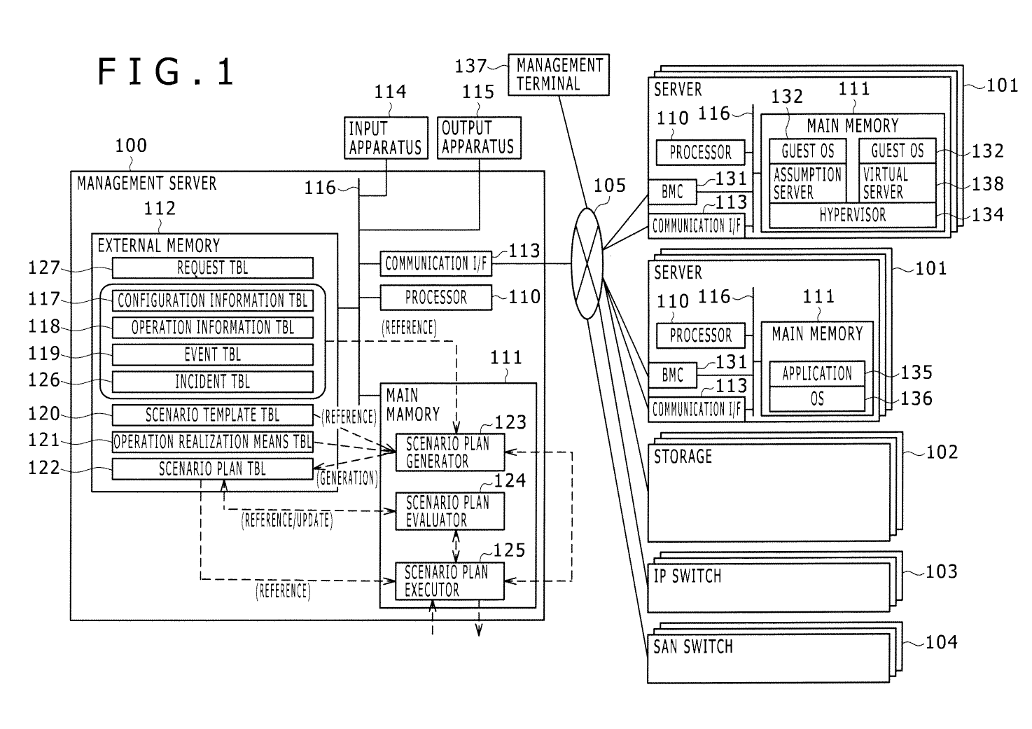

FIG. 1 is a block diagram showing a configuration of the information processing system 1. As shown in FIG. 1, the information processing system 1 includes a management server 100, servers 101, a storage 102, an IP switch 103, and a SAN switch 104.

The management server 100 is a server which manages the servers 101, the storage 102, the IP switch 103, and the SAN switch 104 connected though a network 105. When an execution request of an operation scenario is inputted from a management terminal 137, the management server 100 executes various operations on the servers 101, the storage 102, the IP switch 103, and the SAN switch 104 according to definition content of an operation scenario managed in the management server 100.

As shown in FIG. 1, the management server 100 includes a processor 110, a main memory 111, a communication I/F 113, an input apparatus 114, an output apparatus 115, and an external memory 112.

The processer 110 is an apparatus which functions as an arithmetic processing apparatus and a control apparatus and performs control of each apparatus in the management server 100 and calculation/processing of data according to various programs.

The main memory 111 is an apparatus which stores data and programs. The main memory 111 stores various programs such as a scenario plan generator 123, a scenario plan evaluator 124, and a scenario plan executor 125.

The scenario plan generator 123 is a processing part which generates a scenario plan that materializes operations defined in an operation scenario. The scenario plan generator 123 reads a scenario requested to be executed from a scenario template table 120 and thereafter reads a realization means of an operation defined in the scenario from an operation realization means table 121, materializes the realization means, and generates a scenario plan where the scenario is materialized by the realization means.

The scenario plan evaluator 124 is a processing part which evaluates scenario plans on the basis of a specified or a predetermined evaluation index when there are one or more scenario plans that materialize the same operation scenario. The scenario plan evaluator 124 evaluates a scenario plan on the basis of information stored in a configuration information table 117, an operation information table 118, an event table 119, and an incident table 126. As evaluation indexes, the scenario plan evaluator 124 performs evaluation from viewpoints whether the scenario plan can be realized, whether the scenario plan can be executed quickly (how long the waiting time is from when an execution request is issued), and how fast the scenario plan execution is completed when the scenario plan is executed. Whether the scenario plan can be realized is determined on the basis of an API of a realization means of an operation and an operation path when a command line is executed, specifically, path information indicating which network is used and to which software process a command is transmitted. If a failure occurs in the network or a failure occurs in the software where the command is executed, it is determined that the scenario plan cannot be executed.

The scenario plan executor 125 is a processing part which receives an execution request of an operation scenario and executes an operation according to definition content of the operation scenario. The scenario plan executor 125 generates one or more scenario plans where a scenario is materialized by a realization means through the scenario plan generator 123 and then selects one scenario plan from a plurality of scenario plans and executes the selected scenario plan. When selecting a scenario plan, the scenario plan executor 125 selects a scenario plan having the highest evaluation value evaluated by the scenario plan evaluator 124, so that the scenario plan executor 125 selects a scenario plan most suitable to the situation.

The communication I/F 113 is an apparatus which transmits and receives data in the management server 100 through the network 105.

The input apparatus 114 is an input device which inputs information into the management server 100. The output apparatus 115 is an output device which outputs information managed by the management server 100.

Examples of the input/output devices include a display, a keyboard, and a pointing device. However, the input/output devices may be devices other than the above. A serial interface or an Ethernet interface may be configured to be input/output devices as an alternative for the input/output devices. In this case, input and display of the input/output devices are substituted by connecting a display computer including a display, a keyboard, or a pointing device to the interface, displaying information on the display computer by transmitting display information to the display computer, and accepting input by receiving input information from the display computer.

Hereinafter, a set of one or more computers that manage the information processing system 1 and display the display information of the present invention may be referred to as a management system. When the management server 100 displays the display information, the management server 100 is the management system. A pair of the management server 100 and the display computer is also the management system. A plurality of computers may realize the same process as that of the management server 100 in order to improve speed and reliability of a management process. In this case, the plurality of computers (including the display computer when display is performed by the display computer) are the management system.

The external memory 112 is a storage medium or a storage apparatus. The external memory 112 may be a hard disk drive or a solid state drive using a flash memory. Also, the external memory 112 may be a hard disk drive included in the management server 100 or a solid state drive included in the management server 100. Also, the external memory 112 may be a storage apparatus or a storage medium on the storage 102.

The external memory 112 stores various tables such as a request table 127, the configuration information table 117, the operation information table 118, the event table 119, the incident table 126, a scenario template table 120, an operation realization means table 121, and a scenario plan table 122.

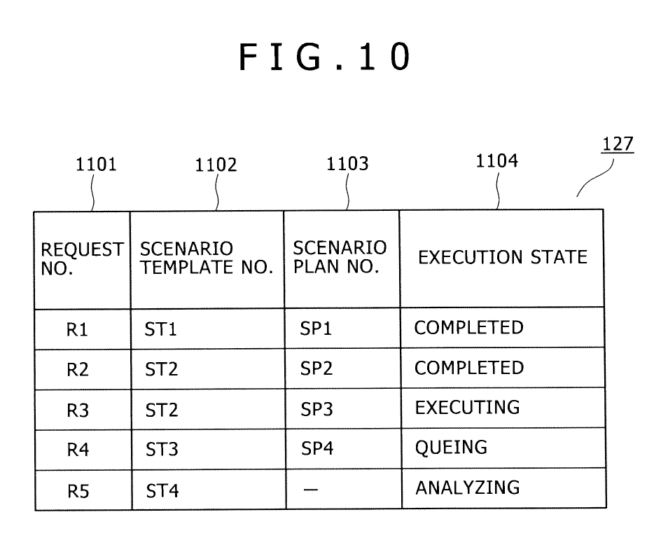

The request table 127 is a table which manages an execution request of an operation that is requested to the management server 100. The execution request of an operation is an execution request of a scenario inputted from the input apparatus 114, an execution request of a scenario which is inputted from the management terminal 137 and requested to the management server 100 through the network 105, and the like. The content of the request table 127 will be described later in detail with reference to FIG. 10.

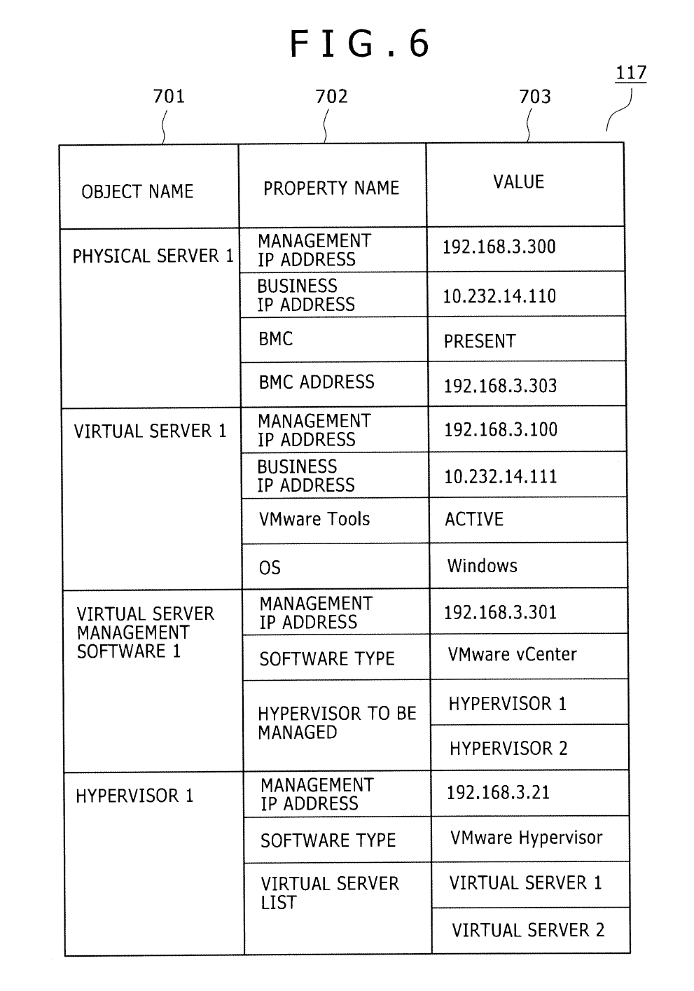

The configuration information table 117 is a table which stores configuration information of management target apparatuses and management target software of the management server 100. The content of the configuration information table 117 will be described later in detail with reference to FIG. 6.

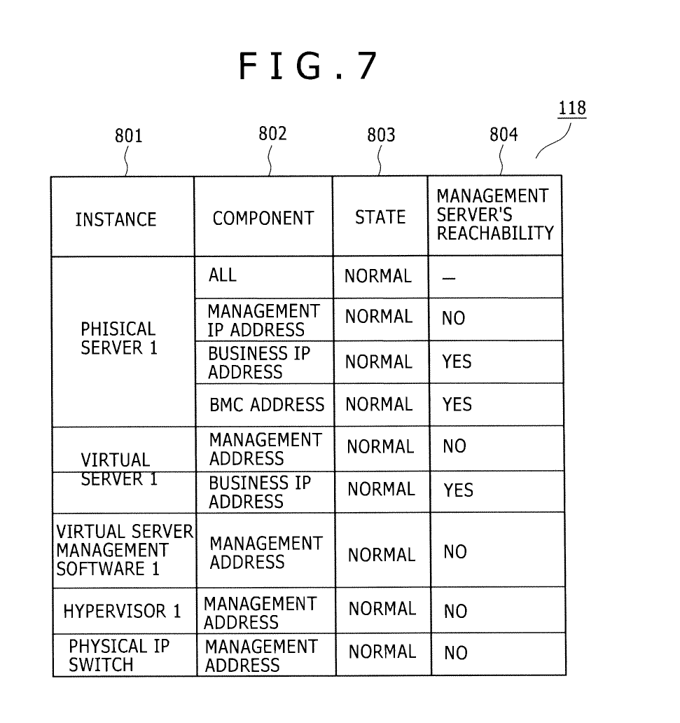

The operation information table 118 is a table which stores operation information of the management target apparatuses and the management target software of the management server 100. The content of the operation information table 118 will be described later in detail with reference to FIG. 7.

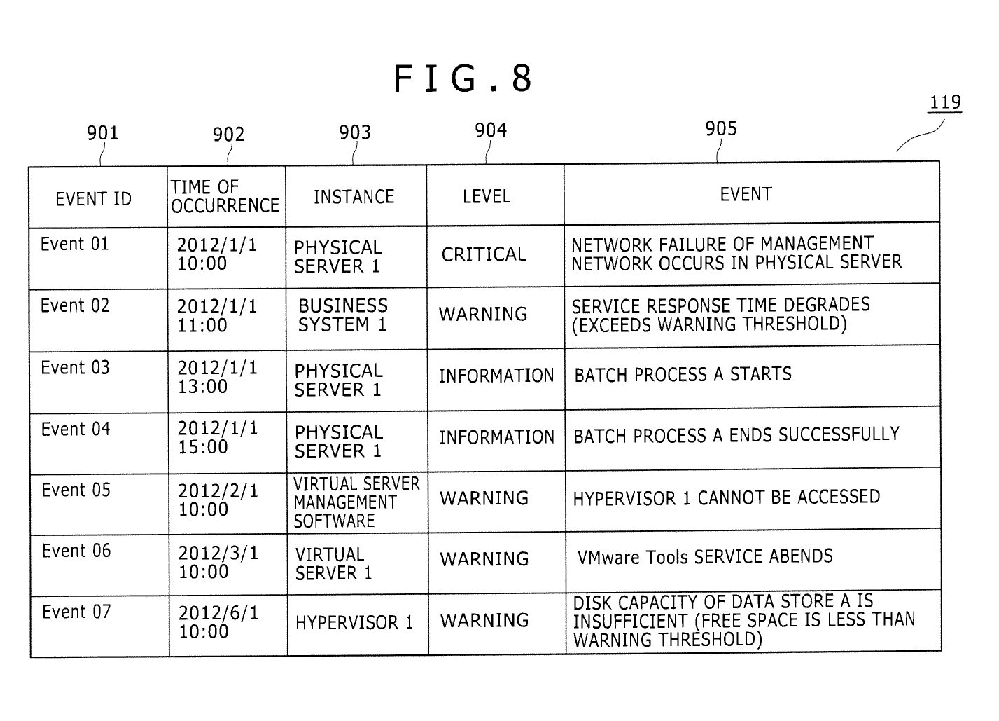

The event table 119 stores event information notified from a management target of the management server 100 and event information issued by the management server 100 on the basis of the configuration information stored in the configuration information table 117 and the operation information stored in the operation information table 118. Examples of the event information include event information related to a failure and event information related to a configuration change. The content of the event table 119 will be described later in detail with reference to FIG. 8.

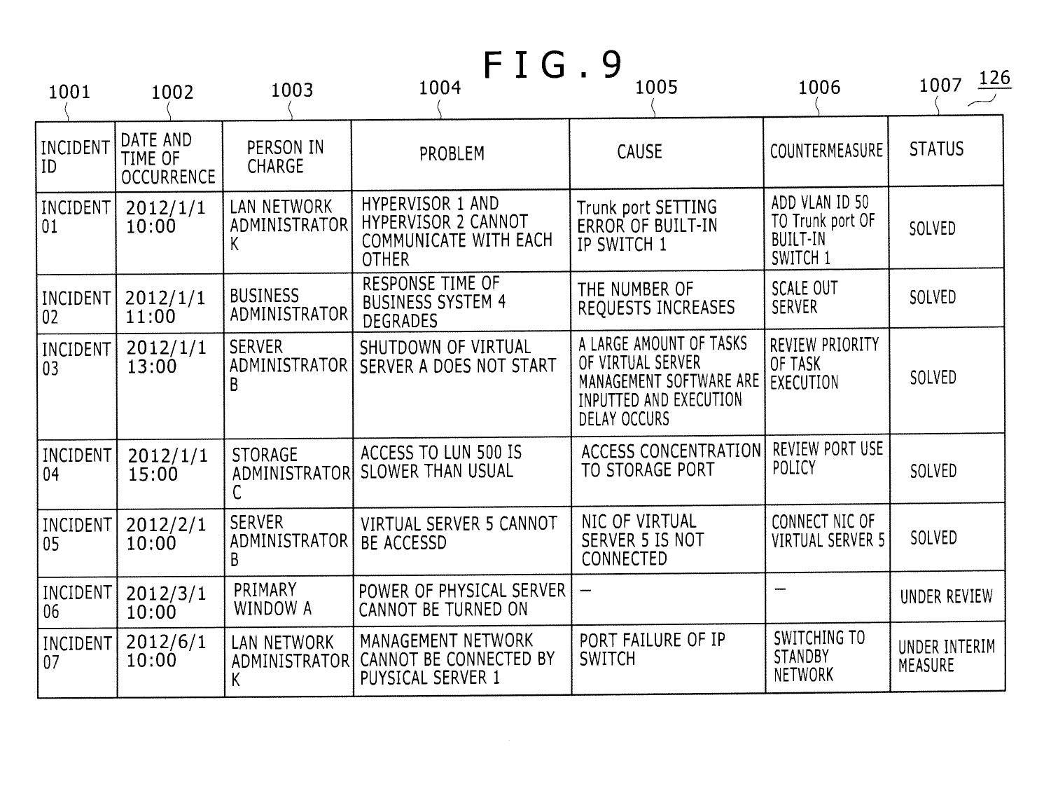

The incident table 126 is a table which stores an event and a problem (incident information) of a management target of the management server 100 and a response status of the event/problem. It is possible to know an occurrence status of a failure and a recovery state from a failure on the basis of the incident information stored in the incident table 126. The content of the incident table 126 will be described later in detail with reference to FIG. 9.

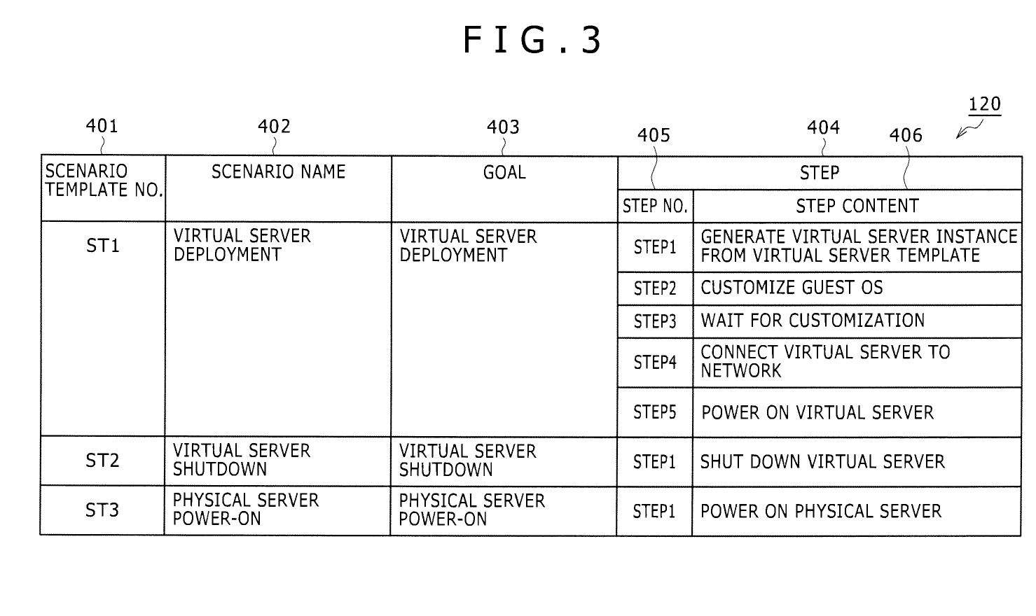

The scenario template table 120 is a table which stores definition content of a scenario. As a scenario stored in the scenario template table 120, a procedure of an operation is stored in the scenario template table 120. The operation stored in the scenario template table 120 is an abstract operation where a realization means is not materialized. The content of the scenario template table 120 will be described later in detail with reference to FIG. 3.

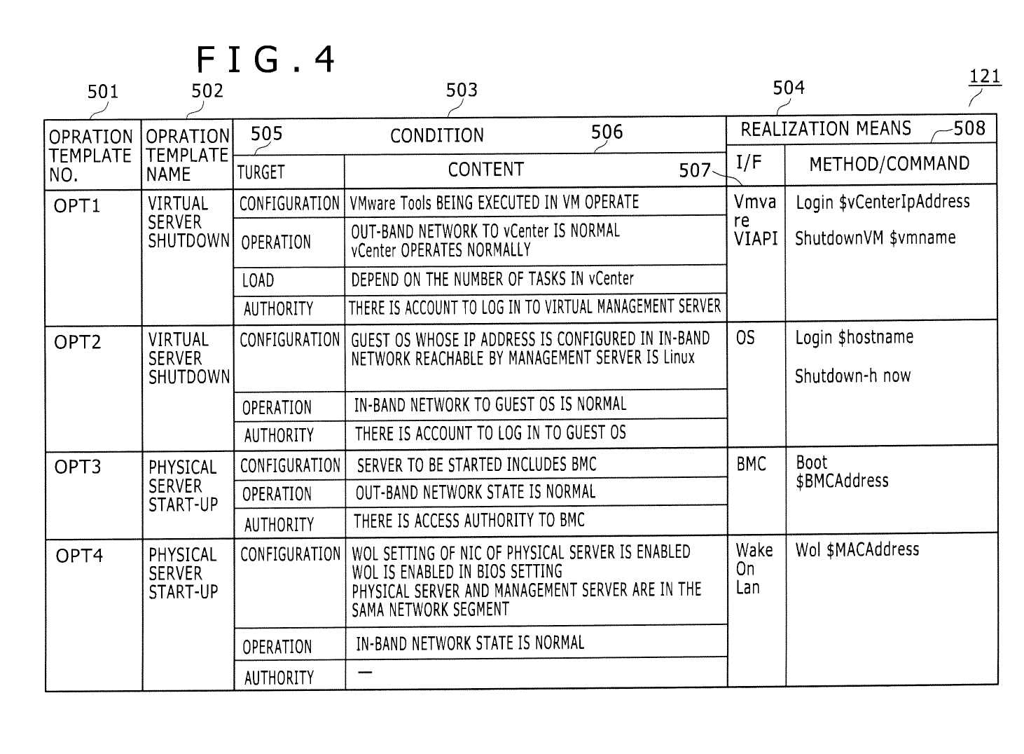

The operation realization means table 121 is a table which stores correlation information between abstract operation definition and definition information of a concrete realization means of the operation. Definition information of one or more realization means can be associated with one operation definition information. The definition information of the realization means includes operation execution path information indicating through what network 105 the operation is executed and to what software a command is issued. The content of the operation realization means table 121 will be described later in detail with reference to FIG. 4.

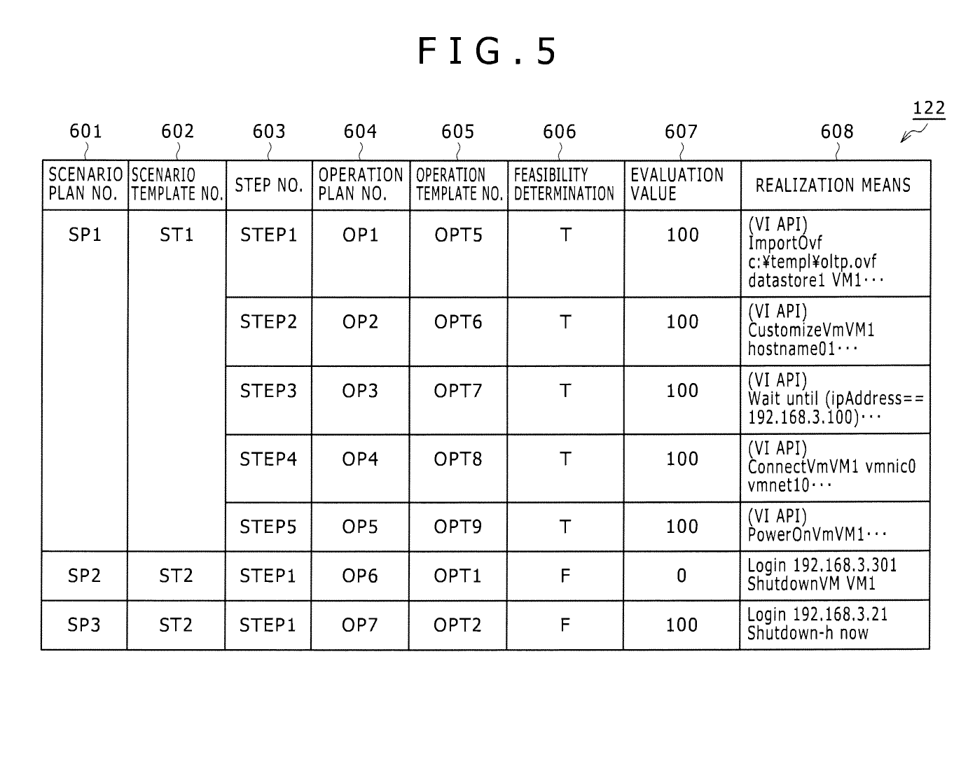

The scenario plan table 122 is a table which stores a scenario plan where a scenario is materialized by a realization means according to an execution request of an operation. The scenario plan is stored in association with the execution request of the operation. When there are multiple scenario plans generated on the basis of the execution request, the plurality of scenario plans and the execution request are stored in association with each other. The content of the scenario plan table 122 will be described later in detail with reference to FIG. 5.

Among the tables described above, the configuration information table 117, the operation information table 118, the event table 119, and the incident table 126 are information for the management server 100 to know the states of the management targets managed by the management server 100. When there are one or more scenario plans materialized for a certain scenario, these tables are used as information to determine which scenario plan is selected.

For example, it is possible to specify a failure generation position and an affected area on the basis of the information of the tables and select a scenario plan that is not affected by the failure. Whether or not a failure occurs can be determined by associating topology generated from the configuration information with the operation information. Also, a failure can be determined from the event information and the incident information (response status of the incident). The information of the tables can be used as information to determine whether or not a prerequisite to execute the scenario plan is satisfied. For example, it is possible to determine that software required by the scenario plan is absent on the basis of the configuration information, so that the scenario plan can be excluded.

The storage 102 is an external storage apparatus which stores data. Although not shown in the drawings, the storage 102 includes a storage control part which controls the storage 102 and controls a RAID and an I/O. Here, the storage 102 is one of nodes to be managed by the management server 100.

The management terminal 137 is an information processing apparatus which receives input from an administrator and outputs various information items to the administrator. Although not shown in the drawings, the management terminal 137 includes an input/output part, an output part, and a transmission/reception part. The input/output part receives input from the administrator and transmits input information to the management server 100 through the transmission/reception part via the network 105. Also, the input/output part receives information from the management server 100 via the network 105 through the transmission/reception part and outputs the information to the administrator.

The server 101 is a physical computer other than the management server 100. The server 101 is one of the nodes to be managed by the management server 100. The server 101 includes a processor 110, a main memory 111, a BMC 131, a communication I/F 113, and the like. The processor 110, the main memory 111, the BMC 131, and the communication I/F 113 are connected through a bus 116.

The processer 110 is an apparatus which functions as an arithmetic processing apparatus and a control apparatus and performs control of each apparatus in the server 101 and calculation/processing of data according to various programs.

The main memory 111 is an apparatus which stores data and programs.

The BMC 131 is a controller to manage a system. The BMC 131 has a function to monitor a fatal hardware error of the server 101 at all times and notify an OS 136 and a hypervisor 134 of the error. Specifically, the BMC 131 monitors a voltage supplied from a power supply unit of the server 101, the number of rotations of a cooling fan, temperatures of various parts including the processor, a power supply voltage of a SCSI terminator, and the like. Even when the power of the main body is off, if a power cord is connected to the power supply unit, power is supplied to the BMC 31 and the monitoring is continued.

The communication I/F 113 is an apparatus which transmits and receives data of the server 101 through the network 105.

The bus 116 is a communication path through which data in components on the server 101 such as the processor 110, the main memory 111, and the communication I/F 113 is transmitted and received.

The hypervisor 134 may operate on the server 101 and the OS 136 may operate on the server 101. The hypervisor 134 and the OS 136 are stored on the external memory 112 on the server and realized by being read into the main memory 111. The hypervisor 134 may be dedicated hardware. When the hypervisor 134 operates, one or more virtual servers 138 operate on the hypervisor 134.

The virtual server 138 is a computer environment virtually reproduced in the server 101. The virtual server 138 is an environment obtained by physically or logically dividing a computing resource of the server 101 by the hypervisor 134 described later. The virtual server 138 is also referred to as so-called VM, PPAR, and LPAR. The virtual server 138 is one of the nodes that can be a management target of the management server 100.

The virtual server 138 includes a guest OS 132. The guest OS 132 is a general operating system. For example, the guest OS 132 is Windows (registered trademark), Linux (registered trademark), HP-UX (registered trademark), Solaris (registered trademark), VOS3 (registered trademark), or z/OS (registered trademark). The guest OS 132 is one of the nodes that can be a management target of the management server 100.

The hypervisor 134 is virtualization software or a virtualization mechanism operating on the server 101 and has a function to physically or logically divide resources such as the processor 110 and the main memory 111 included in the server 101 and to operate the virtual server 138. For example, the hypervisor 134 is VMware vSphere Hypervisor (registered trademark), Hyper-V (registered trademark), Virtage (registered trademark), KVM (registered trademark), XenServer (registered trademark), or Oracle VM (registered trademark). The hypervisor 134 is one of the nodes to be managed by the management server 100.

The OS 136 is a general operating system. For example, the guest OS 132 is Windows (registered trademark), Linux (registered trademark), HP-UX (registered trademark), Solaris (registered trademark), VOS3 (registered trademark), or z/OS (registered trademark). Here, the OS 136 is one of the nodes that can be a management target of the management server 100.

Application software 135 operates on the OS 136 or the guest OS 132. The application software 135 includes business software such as ERP and CRM, middleware such as a Web 3-layer system, an application container, and DBMS, and management software.

As an example of the management software, there is virtualization management software having a function to manage the hypervisor 134 and the virtual server 138. The management server 100 can collect information of the hypervisor 134 and the virtual server 138, operate the hypervisor 134 and the virtual server 138, and deploy the virtual server 138 onto the hypervisor 134 from the virtual server 138 through a management interface of the virtualization management software. Examples of the virtualization management software include vCenter Server (registered trademark) of VMware Inc. and System Center Virtual Machine Manger (registered trademark) of Microsoft Corp.

### (1-2) Summary of Operation Scenario

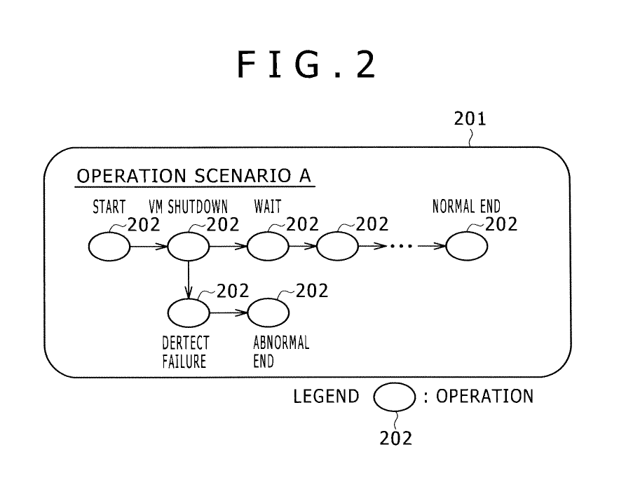

Next, the operation scenario executed by the management server 100 will be described. FIG. 2 is a conceptual diagram of the operation scenario and operations.

The operation scenario 201 comprises a series of one or more operations 202. The operation is an execution command (an API method call or a command line execution) to a management target apparatus and management target software, such as start process, shutdown of the virtual server, wait for completion of the previous operation, conditional judgment for detecting a failure, normal end, and abnormal end, and processes on the management server. Relationships between the operations can be represented by a digraph and the digraph indicates an execution sequence. In principle, after the previous operation is completed, the next operation is started.

### (1-3) Content of Various Tables

Next, the content of the aforementioned various tables will be described.

FIG. 3 is a diagram showing an example of the scenario template table 120. As shown in FIG. 3, the scenario template table 120 comprises scenario template number fields 401, scenario name fields 402, goal fields 403, and step fields 404.

The scenario template number field 401 stores identification information that uniquely identifies a scenario. The scenario name field 402 stores a name of the scenario. The goal field 403 stores content of the scenario. The content of the scenario means content realized by executing the scenario. The step fields 404 store each step of operations comprised in the scenario.

The step field 404 comprises a step number field 405 and a step content field 406. The step number field 405 stores a step number of the operation. The step content field 406 stores content of the operation in each step. Steps of operations stored in entries of a certain scenario template table 120 indicate that the operations are sequentially executed in ascending order of the step number.

FIG. 4 is a diagram showing an example of the operation realization means table 121. The operation realization means table 121 is a table which stores realization means information of an operation described in an operation template.

The operation realization means table 121 comprises operation template number fields 501, operation template name fields 502, condition fields 503, and realization means fields 504.

The operation template number field 501 stores number information for identifying an operation template. The operation template number fields 501 may store the same operation identification numbers.

The operation template name field 502 stores a name of the operation template. The condition field 503 stores a prerequisite to execute the operation template identified by the operation template number field 501 by a realization means described in the realization means field 504.

The condition field 503 comprises a target field 505 and a content field 506. The target field 505 stores a category for classifying the conditions. Here, the conditions are classified into categories of configuration information, operation information, load, and authority.

The content field 506 stores content of the condition. For example, an operation of “Virtual server shutdown” defined in OPT1 in the operation template number field 501 indicates that when prerequisites of the condition of the configuration information “VMware Tools being executed in VM operate”, the condition of the operation information “Out-band network to vCenter is normal”, and the condition of the authority “There is account to log in to virtual management server” are satisfied, a process of “Login $vCenterIpAddress && ShutdownVM $vmname” described in the realization means can be executed. The condition of the load information may also be included. A determination of which conditions are included is performed by a policy determination of the scenario plan executor 125 or the scenario plan evaluator 124.

The realization means field 504 stores a realization means which is materialized from the operation template that can be identified by the operation template number field 501. The realization means field 504 comprises an interface field 507 and a method/command field 508.

The interface field 507 stores an API to execute a realization means, execution destination information of a command line, and path information to when an operation is executed. The path information is network information used when the operation is executed, software information of the execution destination, and the like.

The method/command field 508 stores content of a specific execution process of the operation actually executed by using the interface information and the path information stored in the interface field 507. The content of the execution process of the operation is definition content of a process obtained by abstracting unique information of a system on which the operation is executed and an apparatus/infrastructure on which the operation is executed by variable definition.

FIG. 5 is a diagram showing an example of the scenario plan table 122. The scenario plan table 122 comprises scenario plan number fields 601, scenario template number fields 602, step number fields 603, operation plan number fields 604, operation template number fields 605, feasibility determination fields 606, evaluation value fields 607, and realization means fields 608.

The scenario plan number field 601 stores an identification number that identifies a scenario plan that materializes steps of each operation in the scenario template table 120 from the operation execution request.

The scenario template number field 602 stores an identification number that identifies a scenario template that is the basis of the scenario plan.

The step number field 603 stores an identifier that identifies an operation of each step of the scenario template specified in the scenario template number field 602.

The operation plan number field 604 stores an identification number of a materialized operation. The operation template number field 605 stores an identification number that identifies an operation template that is the basis of the operation plan identified in the operation plan number field 604.

The feasibility determination field 606 stores a determination result indicating whether or not the scenario plan can be executed. The feasibility determination field 606 stores “T” which indicates that the scenario plan can be executed or “F” which indicates that the scenario plan cannot be executed. For example, if it is determined that the operation plan cannot be executed because a failure occurs in the network and API cannot be issued to an execution request destination, “F” is stored in the feasibility determination field 606.

The evaluation value field 607 stores an execution priority of the scenario plan. When there are multiple specific scenario plans for the same scenario, the scenario plans are executed in order from the highest priority to the lowest priority by referring to the values stored in the evaluation value fields 607. Also, the plurality of scenario plans materialized by the realization means are displayed to a user who issued the execution request of the operation scenario and the scenario plans are displayed in association with the evaluation values. The user can select a desired scenario plan from the displayed scenario plans.

The realization means field 608 stores content of the operation realization means for each operation plan number field 604. The realization means field 608 stores realization means content which is materialized by management target apparatuses and management target software of the management server 100 and execution request destination information of an API according to the execution request.

FIG. 6 is a diagram showing an example of the configuration information table 117. The configuration information table 117 is a table which manages configuration information related to the management targets managed by the management server 100. The configuration information table 117 comprises object name fields 701, property name fields 702, and value fields 703.

The object name field 701 stores instance information included in the configuration information. The property name field 702 stores an attribute name included in the instance specified in the object name field 701. The value field 703 stores a value of actual configuration information of the attribute information specified in the property name field 702.

FIG. 7 is a diagram showing an example of the operation information table 118. The operation information table 118 is a table which manages operation information of the management targets managed by the management server 100. The operation information table 118 comprises instance fields 801, component fields 802, state fields 803, and management server's reachability fields 804.

The instance field 801 stores instance information included in the operation information. The component field 802 stores component information comprised in the instance and network address information of the component. The state field 803 stores information of an operational state of the component. The management server's reachability field 804 stores information indicating whether or not the management server 100 can access the component.

FIG. 8 is a diagram showing an example of the event table 119. The event table 119 is a table which manages event information of the management targets managed by the management server 100. The management server 100 can detect occurrence of a failure, content of the failure, and the occurrence position of the failure on the basis of the information stored in the event table 119.

The event table 119 comprises event ID fields 901, time of occurrence fields 902, instance fields 903, level fields 904, and event fields 905.

The event ID field 901 stores identification information that uniquely identifies an event. The time of occurrence field 902 stores time of occurrence of the event. The instance field 903 stores instance information included in the event. The level field 904 stores a level of importance of the event. The event field 905 stores specific content of the event.

FIG. 9 is a diagram showing an example of the incident table 126. The incident table 126 is a table which manages occurrence of a failure, content of the failure, and the occurrence position of the failure. The management server 100 can detect occurrence of a failure, content of the failure, and the occurrence position of the failure on the basis of the information stored in the incident table 126. The incident table 126 also manages information of a failure where an event or the like is not automatically issued.

As shown in FIG. 9, the incident table 126 comprises incident number fields 1001, date and time of occurrence fields 1002, person in charge fields 1003, problem fields 1004, cause fields 1005, countermeasure fields 1006, and status fields 1007.

The incident number field 1001 stores identification information that identifies an incident. The date and time of occurrence field 1002 stores date and time of registration of the incident. The person in charge field 1003 stores information of a person in charge of the incident. The problem field 1004 stores content (problem) of the incident. The cause field 1005 stores information indicating a cause of the incident. The countermeasure field 1006 stores a countermeasure against the problem of the incident. The status field 1007 stores a response status to the problem of the incident.

FIG. 10 is a diagram showing an example of the request table 127. The request table 127 is a table which manages a scenario plan selected to be executed from one or more scenario plans for an execution request of an operation scenario managed by the management server 100.

As shown in FIG. 10, the request table 127 comprises request number fields 1101, scenario template number fields 1102, scenario plan number fields 1103, and execution state fields 1104.

The request number field 1101 stores an identification number that uniquely identifies an execution request of an operation scenario managed by the management server 100. The scenario template number field 1102 stores an identification number which identifies a scenario template specified by the execution request of the operation scenario. The scenario plan number field 1103 stores an identification number that uniquely identifies a scenario plan that is materialized from the scenario template number. Responding to the execution request of the operation scenario, an identifier of a scenario plan selected to be executed from one or more scenario plans is stored. The execution state field 1104 stores an execution state of an operation execution request.

### (2) Details of Operation Scenario Execution Process

Next, an operation scenario execution process will be described. First, an execution process of an operation scenario by the scenario plan executor 125 will be described.

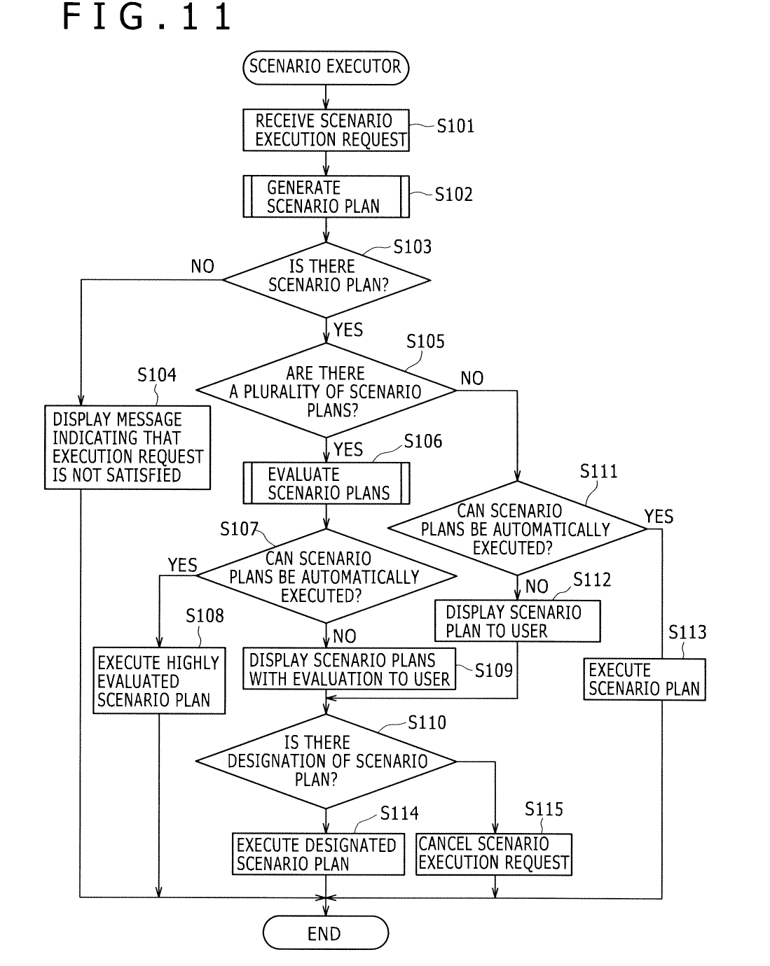

As shown in FIG. 11, first, the scenario plan executor 125 receives a scenario execution request from a user through the management terminal 137 (S101).

Then, the scenario plan executor 125 provides the scenario execution request received in step S101 to the scenario plan generator 123 and causes the scenario plan generator 123 to generate a scenario plan (S102). The scenario plan generation process in step S102 is executed by the scenario plan generator 123. The scenario plan generation process by the scenario plan generator 123 will be described later in detail.

The scenario plan executor 125 determines whether or not the scenario plan is generated by the scenario plan generator 123 (S103).

If it is determined in step S103 that the scenario plan is not generated, the scenario plan executor 125 displays a message indicating that the execution request received from the user cannot be satisfied on a display screen of the management terminal 137 (S104) and ends the process.

If it is determined in step S103 that the scenario plan is generated, the scenario plan executor 125 determines whether or not a plurality of scenario plans are generated in step S102 (S105). As described above, there may be a plurality of specific operation realization means configured for one scenario template.

If it is determined in step S105 that a plurality of scenario plans are generated, the scenario plan executor 125 evaluates which plan is the most suitable plan (S106). The evaluation of the scenario plans in step S106 is performed by the scenario plan evaluator 124.

As described above, the scenario plan evaluator 124 performs the evaluation of the scenario plans from viewpoints whether the scenario plan can be realized, whether the scenario plan can be executed quickly (how long the waiting time is from when the execution request is issued), and how fast the scenario plan execution is completed when the scenario plan is executed.

Next, the scenario plan executor 125 determines whether or not the scenario plans can be automatically executed (S107). Whether or not the scenario plans can be automatically executed is inputted by a user through the management terminal 137.

If it is determined in step S107 that the scenario plans can be automatically executed, the scenario plan executor 125 selects a highly evaluated scenario plan from the plurality of scenario plans and executes the scenario plan (S108).

On the other hand, if it is determined in step S107 that the scenario plans cannot be automatically executed, the scenario plan executor 125 displays results of the evaluation of the scenario plans in step S107 in association with each scenario plan to a user through the management terminal 137 (S109).

The scenario plan executor 125 determines whether or not a scenario plan is specified from the user through the management terminal 137 (S110).

If it is determined in step S110 that a scenario plan is specified, the scenario plan executor 125 executes the specified scenario plan (S114). On the other hand, if it is determined in step S110 that no scenario plan is specified, the scenario plan executor 125 cancels the scenario execution request (S115) and ends the process.

When a plurality of scenario plans are not generated, that is, when only one scenario plan is generated in step S105, the scenario plan executor 125 determines whether or not the scenario plan can be automatically executed (S111).

If it is determined in step S111 that the scenario plan can be automatically executed, the scenario plan executor 125 executes the generated scenario plan (S113) and ends the process. On the other hand, if it is determined in step S111 that the scenario plan cannot be automatically executed, the scenario plan executor 125 displays the scenario plan to the user through the management terminal 137 (S112).

When the scenario plan is specified from the user through the management terminal 137 (S110), the scenario plan executor 125 executes the scenario plan (S114). On the other hand, when the scenario plan is not specified from the user through the management terminal 137 (S110), the scenario plan executor 125 cancels the scenario execution request (S115).

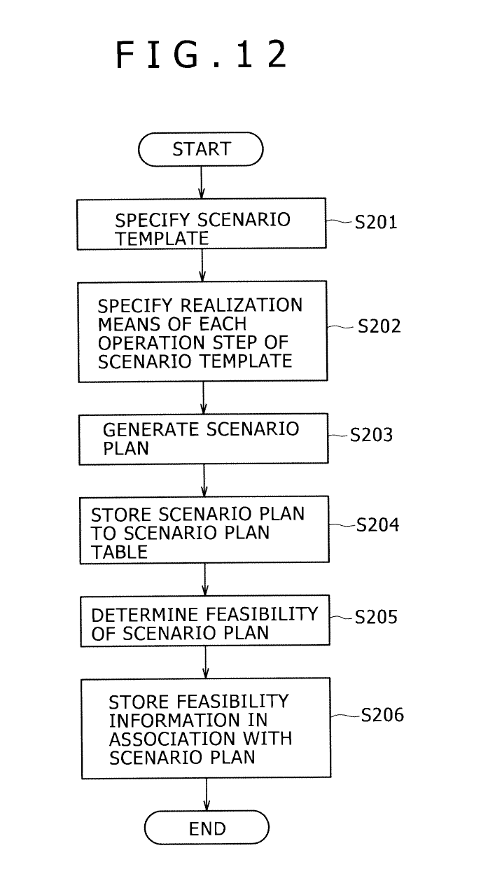

Next, the scenario plan generation process in step S102 will be described. As shown in FIG. 12, first, the scenario plan executor 123 specifies a scenario template according to the scenario execution request received in step S101 from the scenario template table 120 (S201).

Then, the scenario plan generator 123 specifies a realization means of each operation step of the scenario template specified in step S201 (S202). For example, when the scenario template ST1 of the scenario template table 120 is specified, a realization means of the steps from STEP1 to STEP5 to realize a virtual server deployment process is specified.

The scenario plan generator 123 refers to the operation realization means table 121 and generates a scenario plan that specifies the realization means corresponding to the operation steps specified in step S202 (S203). Then, the scenario plan generator 123 stores the generated scenario plan into the scenario plan table 122 (S204).

The scenario plan generator 123 determines the feasibility of the scenario plan generated in step S203 by referring to the configuration information table 117, the operation information table 118, the event table 119, and the incident table 126 (S205).

In step S205, the scenario plan generator 123 determines the feasibility on the basis of configuration conditions required to execute the realization means, such as an API (Application Program Interface) comprised in the realization means, an operation status of an operation path to the execution destination of command line execution, a load state of a component comprised in the operation path, and operation execution authority of the management server. When all the above conditions are satisfied, the scenario plan generator 123 determines that the scenario plan can be executed and when at least one of the conditions is not satisfied, the scenario plan generator 123 determines that the scenario plan cannot be executed.

Here, the operation path is an execution path from the management server 100 to API comprised in each operation and a destination of a command line. For example, when virtual shutdown is realized by using virtual software (VI API), the virtual server 138 is shut down through a first network 105 from the management server 100 to virtualization management software (vCenter) that manages the virtual server 138 and a second network 105 from the virtualization management software (vCenter) to the hypervisor 134. In this case, a path from the first network 105 to the second network 105 is the operation path. Here, the management server 100 does not directly issue an operation to the virtual server 138, so that the management server 100 and the virtual server 138 need not be directly connected to each other on a network 105 (a third network).

On the other hand, an operation path in a case in which the management server 100 directly logs into the guest OS 132 on the virtual server 138 and issues a shutdown command means a network through which the management server 100 is directly connected to the virtual server 138.

In an operation to start the server 101, an operation path of an operation realization means to start the server 101 through the BMC (Base Management Controller) means a network through which the management server 100 is connected to the server 101 to be started. An operation path of an operation realization means to start the server 101 by WOL (Wake on Lan) means a network from the management server 100 to NIC (Network Interface Card) included in the server to be started. The WOL performs a start-up process by issuing a magic packet that is enabled basically in the same segment, so that when the management server 100 and the NIC included in the server 101 to be started are located in the same segment, the operation path is normal, and when the management server 100 and the NIC are not located in the same segment, the operation path is determined to be abnormal.

The feasibility is determined depending on whether the conditions stored in the condition field 503 in the operation realization means table 121 are satisfied.

For example, in a case of the virtual server shutdown, it is determined whether or not a VMware Tools program operates on a virtual server to be shut down by referring to the configuration information table 117. As a result of the determination, when it is determined that the VMware Tools program does not operate, it is determined that the virtual server shutdown cannot be realized.

For example, when an out-band network to management software (vCenter) of an API issue destination of the virtual server shutdown process is normal, it is determined that the virtual server shutdown by an operation template OPT1 can be realized, and on the other hand, when the out-band network is determined to be abnormal, it is determined that the virtual server shutdown by the operation template OPT1 cannot be realized.

Similarly, when an in-band network to a guest OS which is a command issue destination of a virtual server shutdown command is determined to be normal, it is determined that the virtual server shutdown by an operation template OPT2 can be realized, and on the other hand, when the in-band network is determined to be abnormal, it is determined that the virtual server shutdown by the operation template OPT2 cannot be realized.

Here, whether or not a network or the like is failed is determined by referring to, for example, the event table 119 and the incident table 126. For example, regarding a network failure, whether or not a network is failed can be determined by referring to the event table 119 and checking whether or not an event corresponding to a failure is issued in a network switching instance comprised in the network. Also, whether or not a network is failed can be determined by referring to the event table 126 and checking whether or not a network failure incident recognized as an unsolved incident is included.

Further, for example, the feasibility may be determined by the presence or absence of an execution authority of an API comprised in the operation realization means and a command line. In a case of a server start-up operation, when the server start-up operation has a start-up authority (credential information such as a user name and a password) of an operation that starts the server 101 through the BMC, it is determined that there is the feasibility of the scenario plan, and when the server start-up operation does not have the start-up authority, it is determined that there is no feasibility of the scenario plan.

The scenario plan generator 123 associates the scenario plan generated in step S203 and feasibility information of each step of the scenario plan with each other and stores the scenario plan and the feasibility information into the scenario plan table 122 (S206).

### (3) Example of Management Screen

### (3-1) Operation Command Reception Screen

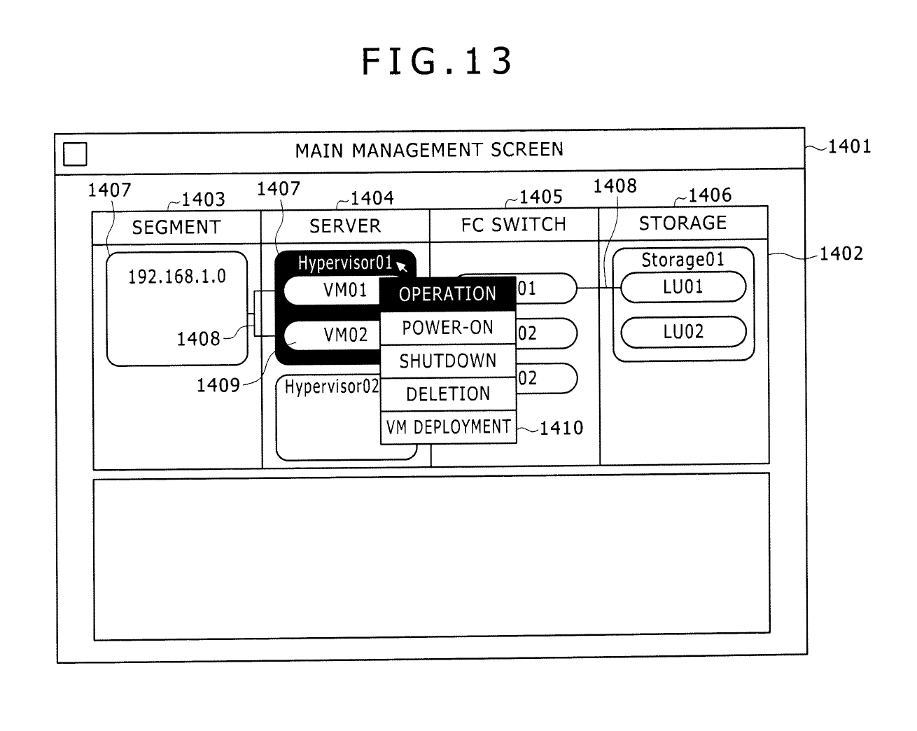

Next, an example of a management screen for receiving an operation execution command from a user will be described. FIG. 13 is an example of a management screen 1401 which is displayed on the management terminal 137 and where an operation execution command from a user is received.

As shown in FIG. 13, the management screen 1401 includes a configuration topology display part 1402 that displays configuration topology of apparatuses and networks. The configuration topology display part 1402 includes a segment display part 1403, a server display part 1404, an FC switch display part 1404, and a storage display part 1406. Each display part displays instance information in which configuration information is collected.

Specifically, the segment display part 1403 displays instance information of a network segment. The server display part 1404 displays instance information of virtual servers and hypervisors. The FC switch display part 1404 displays instance information of FC switches. The storage display part 1406 displays instance information of the storage 102.

The instances can be displayed in a nested form. For example, it is displayed that the instance 1409 includes instances 1407. Regarding instances connected to each other, connection relationships are shown by tie lines 1408.

For example, when right-clicking an instance, a context menu 1410 may be displayed. In the context menu 1410, operations (scenarios) that can be executed on the instance selected by the right-click are displayed. A user can request execution of an operation on the instance by selecting one of the operations displayed in the context menu.

### (3-2) Operation Realization Means Selection Screen

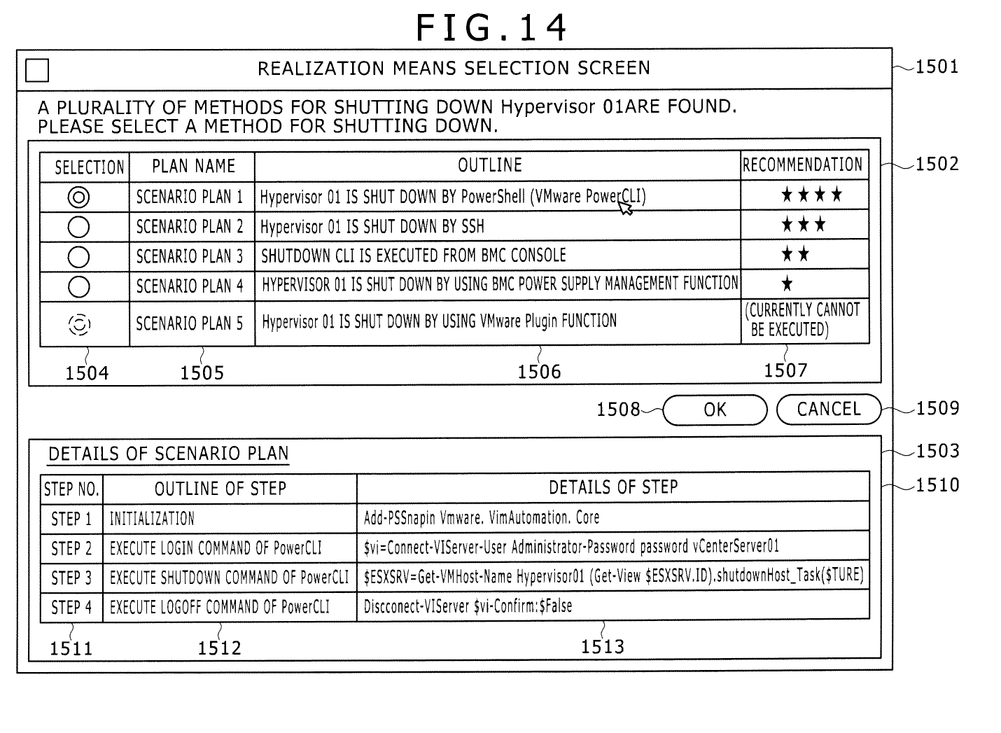

Next, an example of a management screen for displaying candidates of the operation realization means will be described. FIG. 14 is an example of a management screen 1501 which is displayed on the management terminal 137 and which displays candidates of the operation realization means to a user.

As shown in FIG. 14, a realization means selection screen 1501 includes a scenario plan candidate display part 1502, a scenario plan details display part 1503, an OK button 1508, and a cancel button 1509.

In the scenario plan candidate display part 1502, a candidate list of a means (a scenario plan) to realize an operation scenario specified by the user is displayed. The scenario plan candidate display part 1502 includes selection fields 1504, plan name fields 1505, outline fields 1506, and recommendation fields 1507.

The selection fields 1504 include radio buttons for selecting a realization means to be executed by the user from a plurality of scenario plans. The user can select one of records corresponding to the scenario plans listed in the scenario plan candidate display part 1502.

In the plan name fields 1505, plan names of the scenario plans listed in the scenario plan candidate display part 1502 are displayed. In the outline fields 1506, outlines of content of the realization means of the scenario plans are displayed. In the recommendation fields 1507, evaluation values evaluated for each realization means of the scenario plan are scored and displayed. Here, the evaluation values are scored by star signs. The more the number of the star signs is, the higher the evaluation value is.

Among the scenario plans listed in the scenario plan candidate display part 1502, there are scenario plans which are selected as a realization means but determined to be a realization means that cannot be executed because of a failure or a current configuration. In this case, it may be configured so that the realization means, which cannot be executed, are displayed but cannot be selected. For example, regarding the scenario plan 5 in FIG. 14, a scenario plan is generated but the scenario plan cannot be realized in practice, so that the scenario plan is displayed differently from the other scenario plans. For example, as shown in FIG. 14, the scenario plan that cannot be realized may be displayed in italics or characters of the scenario plan may be grayed out.

In the scenario plan details display part 1503, the details of the scenario plan selected in the scenario plan candidate display part 1502 are displayed. In the scenario plan details display part 1503, the details of the scenario plan 1 that is selected in the scenario plan candidate display part 1502 are displayed.

The details of the scenario plan are displayed in a scenario plan details field 1510 in a tabular form. In the scenario plan details field 1510, each step comprised in the scenario plan 1 is displayed. The scenario plan details field 1510 includes step number fields 1511, step outline fields 1512, and step details fields 1513.

In the step number field 1511, an identification number that uniquely identifies a step is displayed. In the step outline field 1512, an outline of each step is displayed. In the step details field 1513, a command line executed in each step is displayed.

Here, the details of the steps displayed in the scenario plan details field 1510 are operation content materialized by a target to be operated. For example, in step 2, a log-in destination is materialized as vCenterSever01, and in step 3, a command in which a hypervisor name to be shut down is materialized as Hypevisor01 is displayed.

The OK button 1508 is a button to determine to execute the scenario plan selected by a user in the scenario plan candidate display part 1502. The cancel button 1509 is a button to cancel the execution of the scenario.

As described above, in the embodiment, it is possible to display one or more scenario plans on the realization means selection screen 1501 for an operation requested by a user to be executed. The user can select a desired scenario plan from one or more scenario plans displayed on the realization means selection screen 1501. On the realization means selection screen 1501, a list of the scenario plans for the operation is displayed and information indicating whether or not each scenario plan can be currently executed is also displayed. Thereby, the user can check information of scenario plans that can be executed without checking operation states of apparatuses and connection states of networks.

### (4) Effects of the Embodiment

As described above, according to the embodiment, a predetermined operation and one or more realization means of the operation are associated with each other and stored in the operation realization means table 121 and the scenario plan generator 123 receives an execution request of an operation and specifies one or more realization means of the operation corresponding to the operation. The scenario plan evaluator 124 selects executable realization means of the operation on the basis of management information such as the configuration information and the operation information of an information processing apparatus connected through a network. Thereby, it is possible to specify one or more realization means of the operation corresponding to the execution request of the operation, select realization means of the operation from the specified realization means of the operation on the basis of the configuration information, the operation information, and the like of the information processing apparatus to be managed, and execute an appropriate operation according to various situations.

What is claimed is:

1. A management system for managing one or more information processing apparatuses through a network, the management system comprising:
a storage part that stores various tables; and
a controller that controls execution of a predetermined operation according to an execution request of the operation,
wherein the storage part stores the predetermined operation and one or more realization means of the operation in association with each other, and
wherein the controller receives the execution request of the operation, specifies one or more realization means of the operation corresponding to the operation, and selects realization means of the operation that can be executed from the specified one or more realization means on the basis of management information including configuration information and operation information of the information processing apparatuses.

2. A management system according to claim 1,
wherein the controller displays information of the selected realization means of the operation that can be executed on a display screen.

3. A management system according to claim 2,
wherein the controller executes a realization means of the operation selected from the realization means of the operation displayed on the display screen according to input of a user.

4. A management system according to claim 1,
wherein the controller determines feasibility of the realization means of the operation on the basis of the management information and executes realization means of the operation that can be executed.

5. A management system according to claim 4,
wherein the controller acquires failure information based on the configuration information or the operation information included in the management information and determines whether or not the realization means of the operation can be executed on the basis of the failure information.

6. A management system according to claim 4,
wherein the controller determines whether or not the realization means of the operation can be executed on the basis of event information, which indicates an event occurring in the information processing apparatuses, included in the management information.

7. A management system according to claim 4,
wherein the controller determines whether or not the realization means of the operation can be executed on the basis of incident information, which indicates an incident occurring in the information processing apparatuses, included in the management information.

8. A management system according to claim 1,
wherein the storage part stores the operation and an operation scenario that defines content of the operation in association with each other, and
wherein the controller specifies the operation scenario corresponding to the execution request of the operation according to the execution request of the operation.

9. A management system according to claim 8,
wherein the storage part stores each step of the operation defined by the operation scenario and realization means to realize each step in association with each other, and
wherein the controller selects realization means corresponding to each step of the specified operation scenario.

10. A computer readable medium storing a program for causing a computer to function as a management system that manages one or more information processing apparatuses through a network,
wherein the management system includes:
a storage part that stores various tables; and
a controller that controls execution of a predetermined operation according to an execution request of the operation,
wherein the storage part stores the predetermined operation and one or more realization means of the operation in association with each other, and
wherein the controller receives the execution request of the operation, specifies one or more realization means of the operation corresponding to the operation, and selects realization means of the operation that can be executed from the specified one or more realization means on the basis of management information including configuration information and operation information of the information processing apparatuses.
